(19) United States
(12) Patent Application Publication
(10) Pub. No.: US 2008/0158420 A1
(43) Pub. Date: Jul. 3, 2008

(54) METHOD FOR CONVERTING VIDEO SIGNAL AND APPARATUS THEREFOR

(75) Inventors: Jin-sub UM, Suwon-si (KR); Moon-cheol KIM, Suwon-si (KR); Sang-jin LEE, Seoul (KR); Se-jin PYO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/766,426

(22) Filed: Jun. 21, 2007

(30) Foreign Application Priority Data
Dec. 29, 2006 (KR) 10-2006-0138783

(51) Int. Cl. H04N 11/06

(52) U.S. Cl. 348/488

(57) ABSTRACT

A method of converting a video signal and an apparatus therefor are provided. According to the method, a type of film to be referred to in order to convert a video signal is selected, and by referring to the characteristic of the selected type of the film, an input video signal is converted.

### CROSS-REFERENCE TO RELATED PATENT APPLICATIONS

This application claims the benefit of Korean Patent Application No. 10-2006-0138783, filed on Dec. 29, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to converting a video signal, and more particularly, to converting an input video signal so that the signal can have a color impression of a film.

2. Description of the Related Art

A telecine technology is a technology for converting an image taken by using an optical film, so that the image can be expressed by using a National Television System Committee (NTSC) broadcasting system.

FIG. 1 is a diagram illustrating a conventional telecine technology.

Referring to FIG. 1, FF1 through FF4 are film frames, 1T, 1B, 1T(r), 2B, 2T, 3B, 3T, 3B(r), 4T and 4B are fields generated through 3:2 pulldown, and BF1 through BF5 are video frames generated through telecine or 3:2 pulldown.

Here, nT (n is a natural number) is the top field of an n-th frame, nB is the bottom filed of the n-th frame, nT(r) is a copy of the n-th top field, and nB(r) is a copy of the n-th bottom field.

Since an image taken by using an optical film has a frame rate of 24 frames per second (fps), in order to reproduce the image in an NTSC broadcasting system, conversion of the image signal is necessary. This conversion is achieved by adding duplicated fields.

Referring to FIG. 1, each 4 frames are converted into 5 frames, by adding 2 additional fields. That is, 24 fps is converted into 30 fps. This process is referred to as telecine or 3:2 pulldown.

Thus, the conventional telecine conversion method, which is a process of converting an image in order to output an image taken by using an optical film through a broadcasting system instead of a projector, exists. However, an image conversion method of converting a broadcasting image signal so that the signal can have a color impression of a film does not exist.

### SUMMARY OF THE INVENTION

The present invention provides a method of and apparatus for converting a digital video signal so that the signal can have a color impression of an image taken by using an optical film.

According to an aspect of the present invention, there is provided a method of converting a video signal including: selecting a type of film to be referred to in order to convert the video signal; and by referring to the characteristic of the selected type of the film, converting the input video signal.

The characteristic of the film may be determined according to the film spectral sensitivity, reflection ratio and transmission ratio of the film, etc.

The converting of the input video signal may include: converting each RGB value of the input image to an energy value of the film indicating the degree that the film is exposed to light; converting the energy value to a pigment concentration value of the film indicating the degree that the pigment is deposited on the film; and converting the pigment concentration value to a tristimulus value.

The converting of the energy value to the pigment concentration value may include: converting the energy value of the film to a density value of the film indicating the exposure degree of the film; and converting the density value of the film to the pigment concentration value of the film.

The converting of the pigment concentration value to the tristimulus value may include: converting the pigment concentration value of the film to a spectral density value of the film indicating the density value of the film with respect to each wavelength; converting the spectral density value of the film to a spectral transmission value of the film indicating the transmission ratio of the film with respect to each wavelength; and converting the spectral transmission value of the film to the tristimulus value.

The method may further include adjusting the tristimulus value based on information on an external environment in which the video signal is reproduced.

The information on the external environment may include information on illumination and chromaticity.

The method may further include converting the tristimulus value to an RGB value adjusted based on the characteristic of color reproduction of an apparatus to reproduce the video signal.

The method may include performing inverse gamma correction of the input video signal in which the nonlinear signal is converted to a linear signal; and in relation to the video signal which is converted to have a color impression of the selected film, performing gamma correction of the video signal in which the linear signal is converted to a nonlinear signal.

According to another aspect of the present invention, there is provided an apparatus for converting a video signal including: a film selection unit selecting a type of film to be referred to in order to convert the video signal; and a film color conversion unit converting the input video signal by referring to the characteristic of the selected type of the film.

The film color conversion unit may include: an energy conversion unit converting each RGB value of the input image to an energy value of the film indicating the degree that the film is exposed to light; a pigment concentration conversion unit converting the energy value to a pigment concentration value of the film indicating the degree that the pigment is deposited on the film; and a tristimulus conversion unit converting the pigment concentration value to a tristimulus value.

The pigment concentration conversion unit may include: an energy-density conversion unit converting the energy value of the film to a density value of the film indicating the exposure degree of the film; and a density-pigment concentration conversion unit converting the density value of the film to the pigment concentration value of the film.

The tristimulus conversion unit may include: a pigment concentration-spectral density conversion unit converting the pigment concentration value of the film to a spectral density value of the film indicating the density value of the film with respect to each wavelength; a spectral density-spectral transmission conversion unit converting the spectral density value of the film to a spectral transmission value of the film indicating the transmission ratio of the film with respect to each wavelength; and a spectral transmission-tristimulus conversion unit converting the spectral transmission value of the film to the tristimulus value.

The apparatus may further include a tristimulus adjustment unit adjusting the tristimulus value based on information on an external environment in which the video signal is reproduced.

The apparatus may further include an RGB conversion unit converting the tristimulus value to an RGB value adjusted based on the characteristic of color reproduction of an apparatus to reproduce the video signal.

The apparatus may further include an inverse gamma correction unit performing inverse gamma correction of the input video signal in which the nonlinear signal is converted to a linear signal; and a gamma correction unit performing gamma correction of the video signal in which the linear signal is converted to a nonlinear signal, in relation to the video signal which is converted to have a color impression of the selected film.

According to still another aspect of the present invention, there is provided a computer readable recording medium having embodied thereon a computer program for executing a method of converting a video signal wherein the method includes: selecting a type of film to be referred to in order to convert the video signal; and by referring to the characteristic of the selected type of the film, converting the input video signal.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating a conventional telecine technology;

FIG. 2 is a diagram illustrating an apparatus for converting a video signal according to an exemplary embodiment of the present invention;

FIG. 3 is a diagram illustrating a camera spectral sensitivity of an ideal camera;

FIG. 4 is a diagram illustrating a film spectral sensitivity;

FIG. 5 is a diagram illustrating a film color conversion unit according to an exemplary embodiment of the present invention;

FIG. 6 is a diagram illustrating the relationship between an energy value of a film and a film density value;

FIG. 7 is a diagram illustrating a density value of each pigment with respect to wavelength;

FIG. 8 is a diagram illustrating spectral transmission values according to an exemplary embodiment of the present invention;

FIG. 9 is a diagram illustrating spectral energy values according to an exemplary embodiment of the present invention;

FIG. 10 illustrates a color matching function; and

FIG. 11 is a diagram illustrating an operation of a film color conversion unit according to an exemplary embodiment of the present invention.

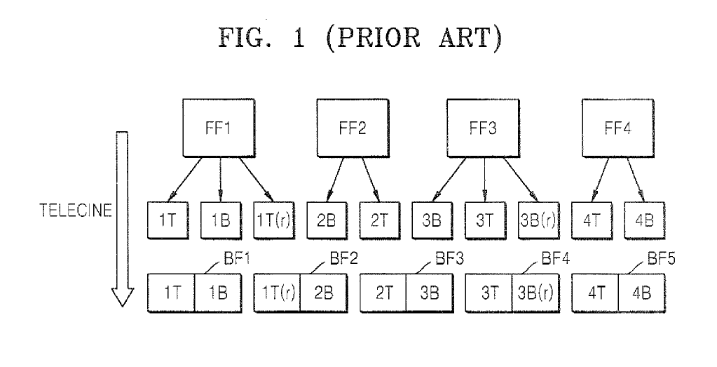

### DETAILED DESCRIPTION OF EXEMPLARY EMBODIMENTS OF THE INVENTION

The present invention will now be described more fully with reference to the accompanying drawings, in which exemplary embodiments of the invention are shown.

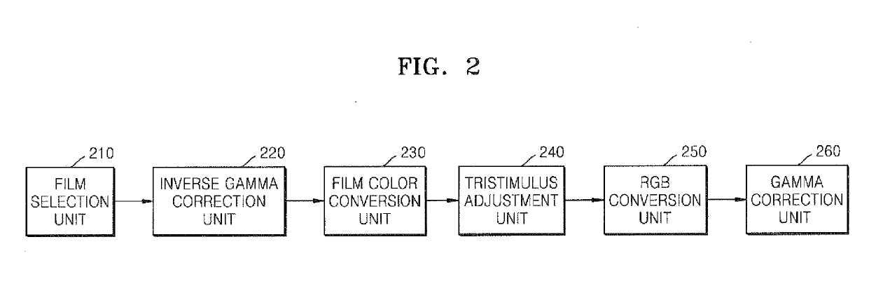

FIG. 2 is a diagram illustrating an apparatus for converting a video signal according to an exemplary embodiment of the present invention.

Referring to FIG. 2, the apparatus for converting a video signal according to the current embodiment is composed of a film selection unit 210, an inverse gamma correction unit 220, a film color conversion unit 230, a tristimulus adjustment unit 240, an RGB conversion unit 250 and a gamma correction unit 260.

If a video signal is input, the film selection unit 210 selects a type of film to be referred to in order to convert the video signal.

In this case, the input video signal may be any type of video signal that can be digitally processed.

Here, the types of films can be classified according to a variety of criteria. When films are classified according to the characteristic of a film, the types of films can be classified according to a film spectral sensitivity, a reflection ratio, and a transmission ratio, for example. In this case, the reflection ratio is a value indicating the degree that light emitted to a film is reflected, and the transmission ratio is the degree that light emitted to a film transmits through the film. The reflection ratio and the transmission ratio vary with respect to films.

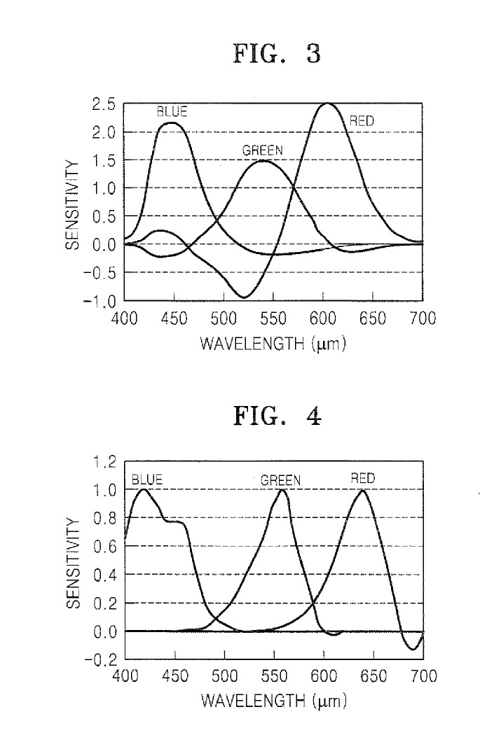

FIG. 3 is a diagram illustrating a camera spectral sensitivity of an ideal camera.

Referring to FIG. 3, blue has a highest sensitivity at a wavelength of approximately 450 μm, green has a highest sensitivity at a wavelength of approximately 550 μm, and red has a highest sensitivity at a wavelength of approximately 620 μm.

FIG. 4 is a diagram illustrating a film spectral sensitivity.

Referring to FIG. 4, blue has a highest sensitivity at a wavelength of approximately 410 μm, green has a highest sensitivity at a wavelength of approximately 550 μm, and red has a highest sensitivity at a wavelength of approximately 650 μm. It can be seen that the graph of FIG. 3 is very different from the graph of FIG. 4. Thus, the film spectral sensitivity varies with respect to the type of a film. That is, a film which is a type different from that of the film shown in FIG. 4 has a film spectral sensitivity different from that of the graph illustrated in FIG. 4.

As described above, since the characteristic of a film varies with respect to the type of the film, the film selection unit 210 selects the type of a film to be referred to in order to convert a video signal. In this case, the characteristic of a film varies according to a film manufacturer.

The film selection unit 210 may select one of existing types of films, and may also select a film to which a film spectral sensitivity, a transmission ratio, and a reflection ratio arbitrarily selected by a user are applied.

The inverse gamma correction unit 220 performs inverse gamma correction of an input video signal in which the nonlinear signal is converted into a linear signal.

That is, the input video signal has nonlinearity, and if the following conversion operations are performed with the nonlinear input video signal, computation becomes complicated. Accordingly, by converting the input video signal into a linear signal, the computation is reduced. However, the inverse gamma correction unit 220 may be omitted according to an implementation.

The film color conversion unit 230 converts the input video signal by referring to the characteristic of the film selected in the film selection unit 210, so that the input video signal can give the color impression of the selected film.

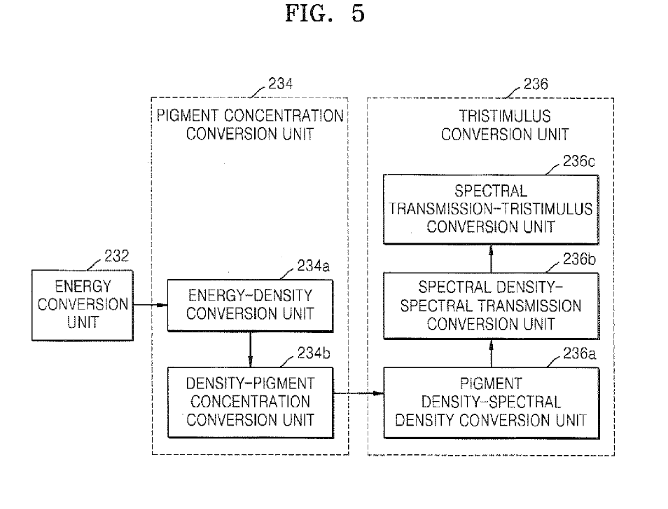

The film color conversion unit 230 will be explained later with reference to FIGS. 5 through 10.

The tristimulus adjustment unit 240 adjusts a tristimulus, which is obtained as a final value in the film color conversion unit 230, based on an external environment in which the video signal is reproduced.

Here, the tristimulus is a color order system which expresses an X-axis indicating the sensitivity of human eyes to a long wavelength (red), a Y-axis indicating the sensitivity to a middle wavelength (green), and a Z-axis indicating the sensitivity to a short wavelength (blue) in relation to a visible ray region.

The tristimulus adjustment unit 240 adjusts tristimulus values based on a variety of external environments in which a video signal is reproduced, and in particular, based on illumination and chromaticity.

For example, in a dark place, human vision becomes sensitive. Accordingly, if screens of an identical brightness are viewed in a dark place and in a bright place, respectively, the screen viewed in the dark place is felt as brighter than that in the bright place. Also, when color of illumination is reddish, an identical screen is recognized to have a bluish color.

Accordingly, when an environment for reproducing a video signal is dark, the tristimulus adjustment unit 240 adjusts the tristimulus values so that the image becomes a little dark, and when illumination is reddish, the tristimulus adjustment unit 240 adjusts the tristimulus values so that the image becomes less bluish. In this case, the tristimulus adjustment unit 240 may use a method of multiplying tristimulus values by predetermined coefficient values so that the tristimulus values can be the adjusted values.

Also, the tristimulus adjustment unit 240 may have a sensor (not shown) capable of recognizing the illumination and chromaticity of an external environment and a memory (not shown) storing information on the external environment.

The RGB conversion unit 250 converts the tristimulus values adjusted in the tristimulus adjustment unit 240 to RGB values adjusted based on the characteristic of color reproduction of an apparatus for reproducing a video signal.

Here, the characteristic of color reproduction may be a different performance of expressing color gradations. That is, even if the same red color is expressed, the color may be expressed redder or less red depending on an apparatus.

For example, when the face of a person is watched on a TV screen, the same face may look redder depending on the TV, and this is a difference characteristic in the color reproduction.

The RGB conversion unit 250 converts the tristimulus values into the RGB values, and then, adjusts the converted RGB values according to the color reproduction characteristic of each apparatus. In the example described above, by reflecting this characteristic, the RGB values are adjusted in the apparatus expressing a red color redder.

In this case, the tristimulus values may be readjusted and then, the readjusted tristimulus values may be converted into an RGB value.

The gamma correction unit 260 converts the RGB values obtained in the RGB conversion unit 250 so that the RGB values have nonlinearity. This is because the current RGB values have linearity, and in order to reproduce the RGB values, the RGB values are converted to have nonlinearity. However, the gamma correction unit 260 may be omitted depending on an implementation.

FIG. 5 is a diagram illustrating a film color conversion unit according to an embodiment of the present invention.

Referring to FIG. 5, the film color conversion unit according to the current embodiment is composed of an energy conversion unit 232, a pigment concentration conversion unit 234 and a tristimulus conversion unit 236.

The energy conversion unit 232 converts the RGB values of an input image into energy values of a film indicating the degree (exposure) that a film is exposed to light.

In this case, the energy conversion unit 232 may use a method of multiplying RGB values by predetermined coefficients as in equation 1 below in order to convert the RGB values into energy values:

E_{R}=c₁R+c₂G+c₃B

E_{G}=c₄R+c₅G+c₆B

E_{B}=c₇R+c₈G+c₉B (1)

The pigment concentration conversion unit 234 includes an energy-density conversion unit 234a and a density-pigment concentration conversion unit 234b.

The energy-density conversion unit 234a converts an energy value of a film into a density of the film indicating exposure of the film.

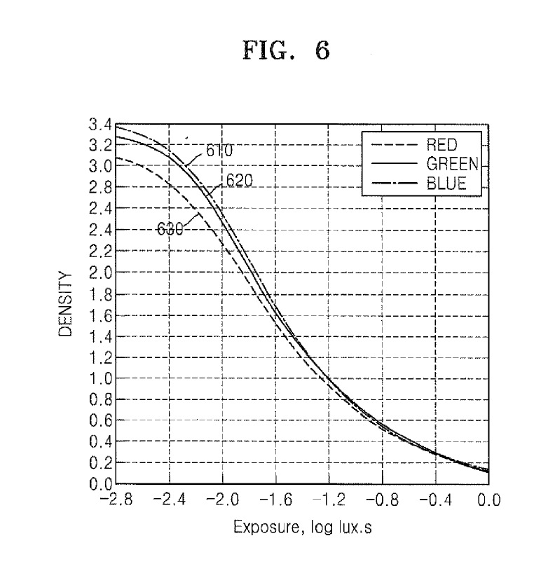

FIG. 6 is a diagram illustrating the relationship between an energy value of a film and a film density value.

Referring to FIG. 6, the relationships between the energy values of a film and the density values of the film are illustrated in relation to blue 610, green 620, and red 630, respectively. The relationships between the energy values and the density values also vary with respect to the type of the film.

The energy-density conversion unit 234a receives an input of energy values of a film on the horizontal axis, and outputs a film density value on the vertical axis based on each graph 610, 620, and 630 of FIG. 6.

That is, the relationship between the energy value and the density value of the film can be expressed as equation 2 below:

D_{RGB}=f(E_{RGB}) (2)

That is, the energy value (E_{RGB}) of the film is substituted in the function (f) of FIG. 6, thereby obtaining a density value (D_{RGB}).

The density-pigment concentration conversion unit 234 converts the density value of the film into the pigment concentration value of the film indicating the degree that the pigment is deposited on the film.

In this case, in order to convert the density value (D_{RGB}) to the pigment concentration value (C_{CMT}) of the film, the density-pigment concentration unit 234b may use a method of multiplying the density value of the film by predetermined coefficients as in equation 3 below:

C_{C}=a₁D_{R}+a₂D_{G}+a₃D_{B}

C_{M}=a₄D_{R}+a₅D_{G}+a₆D_{B}

C_{Y}=a₇D_{R}+a₈D_{G}+a₉D_{B} (3)

The tristimulus conversion unit 236 includes a pigment concentration-spectral density conversion unit 236a, a spectral density-spectral transmission conversion unit 236b, and a spectral transmission-tristimulus conversion unit 236c.

The pigment concentration-spectral density conversion unit 236a converts the pigment concentration value of the film to a spectral density value indicating a density value with respect to each wavelength of the film.

The relationship between the pigment concentration value and the spectral density value (D(λ)) is expressed as in equation 4 below:

D(λ)=d_{c}(λ)C_{c}+d_{M}(λ)C_{M}+d_{Y}(λ)C_{Y}+d_{base}(λ) (4)

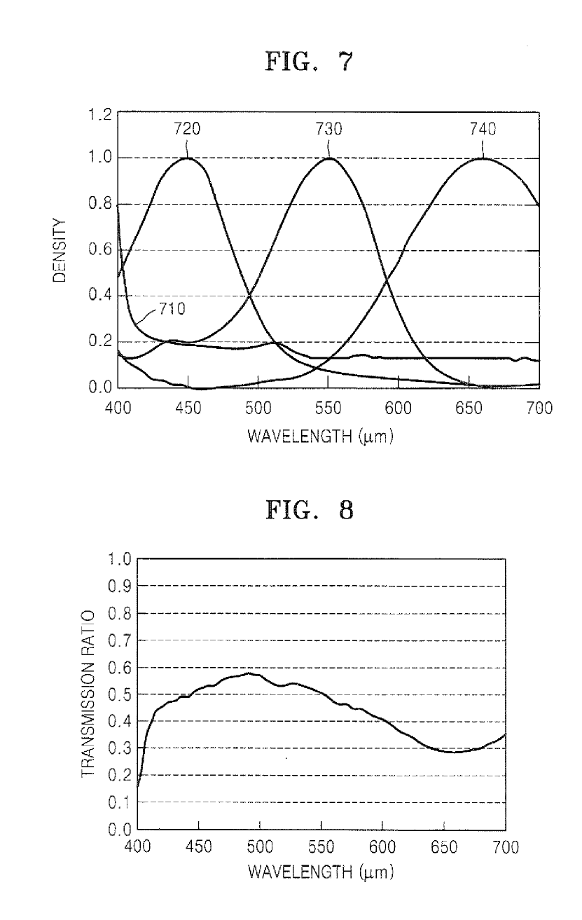

FIG. 7 is a diagram illustrating a density value of each pigment with respect to wavelength.

Referring to FIG. 7, graphs of d_{C}(λ) 740, d_{M}(λ) 730, d_{Y}(λ) 720, and d_{base}(λ) 710 that are density values of each wavelength with respect to cyan, magenta, yellow and a base material, respectively, are illustrated.

The pigment concentration-spectral density conversion unit 236a calculates a spectral density value of the film by using the density values of each pigment and the pigment concentration values of the graphs illustrated in FIG. 7.

The spectral density-spectral transmission conversion unit 236b converts a spectral density value of the film to a spectral transmission value of the film indicating the transmission ratio of the film with respect to a wavelength.

The relationship between the spectral density value (D(λ)) and the spectral transmission value is expressed as equation 5 below:

τ(λ)=10^{-D(λ)} (5)

FIG. 8 is a diagram illustrating spectral transmission values according to an exemplary embodiment of the present invention.

Referring to FIG. 8, it can be seen that the transmission ratio varies with respect to changes in the wavelength. Since the transmission ratio varies with respect to the types of a film, as described above, the graph illustrated in FIG. 8 also varies with respect to the types of the film.

The spectral transmission-tristimulus conversion unit 236c converts the spectral transmission value of the film to a tristimulus value.

The relationship between the spectral transmission value and the tristimulus value of the film is expressed as equation 6 below:

X=k∫S(λ)τ(λ) x̅(λ)dλ

Y=k∫S(λ)τ(λ) y̅(λ)dλ

Z=k∫S(λ)τ(λ) z̅(λ)dλ (6)

Here, S(X) is a spectral energy value indicating the energy quantity of each wavelength, and x̅(λ), y̅(λ), and z̅(λ) are color matching functions.

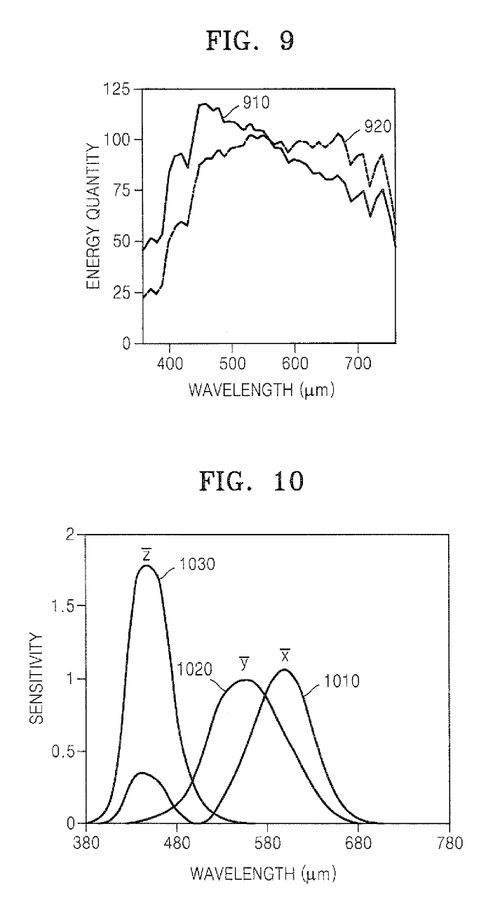

FIG. 9 is a diagram illustrating spectral energy values according to an exemplary embodiment of the present invention.

Referring to FIG. 9, the spectral energy values (S(λ)) of different types of light sources 910 and 920 are illustrated. The light sources illustrated in FIG. 9 are examples of light sources 910 and 920 used in theaters in particular. If the spectral energy value illustrated in FIG. 9 is substituted in equation 6, the spectral energy value that a light source in a theater has can be applied when conversion to tristimulus values is performed.

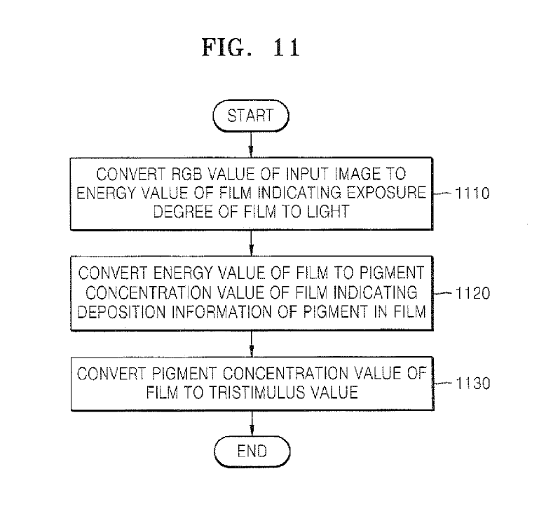

FIG. 10 illustrates a color matching function.

Referring to FIG. 10, x̅ 1010 has a highest sensitivity at a wavelength of approximately 600 μm, y̅ 1020 has a highest sensitivity at a wavelength of approximately 550 μm, and z̅ 1030 has a highest sensitivity at a wavelength of approximately 450 μm.

FIG. 11 is a diagram illustrating an operation of a film color conversion unit according to an embodiment of the present invention.

In operation 1110, the RGB values of an input image are converted to the energy value of a film indicating the degree that the film is exposed to light.

In operation 1120, the energy value of the film is converted to the pigment concentration value of the film indicating the degree that the pigment is deposited on the film.

In operation 1130, the pigment concentration value of the film is converted to tristimulus value.

According to the present invention, if a type of film to be referred to in order to convert a video signal is selected, then, by referring to the characteristic of the selected type of the film, an input video signal is converted. In this way, the digital video signal is converted such that the signal can provide the same color impression as that of an image taken by using an optical film.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of converting a video signal comprising:
selecting a type of film to be referred to in order to convert the video signal; and
by referring to the characteristic of the selected type of the film, converting the video signal.

2. The method of claim 1, wherein the characteristic of the film is determined according to at least one of the film spectral sensitivity, reflection ratio and transmission ratio of the film.

3. The method of claim 1, wherein the converting of the video signal comprises:
converting each RGB value of an input image to an energy value of the film indicating a degree that the film is exposed to light;
converting the energy value to a pigment concentration value of the film indicating a degree that the pigment is deposited on the film; and
converting the pigment concentration value to a tristimulus value.

4. The method of claim 3, wherein the converting the energy value to the pigment concentration value comprises:
converting the energy value of the film to a density value of the film indicating an exposure degree of the film; and
converting the density value of the film to the pigment concentration value of the film.

5. The method of claim 3, wherein the converting the pigment concentration value to the tristimulus value comprises:
converting the pigment concentration value of the film to a spectral density value of the film indicating a density value of the film with respect to each of a plurality of wavelengths;
converting the spectral density value of the film to a spectral transmission value of the film indicating a transmission ratio of the film with respect to each of the plurality of wavelengths; and
converting the spectral transmission value of the film to the tristimulus value.

6. The method of claim 3, further comprising adjusting the tristimulus value based on information on an external environment in which the video signal is reproduced.

7. The method of claim 6, wherein the information on the external environment includes information on illumination and chromaticity.

8. The method of claim 3, further comprising converting the tristimulus value to an RGB value adjusted based on the characteristic of color reproduction of an apparatus to reproduce the video signal.

9. The method of claim 1, further comprising:
performing inverse gamma correction of the video signal in which the nonlinear signal is converted to a linear signal; and
in relation to the video signal which is converted to have a color impression of the selected film, performing gamma correction of the video signal in which the linear signal is converted to a nonlinear signal.

10. An apparatus for converting a video signal comprising:
a film selection unit which selects a type of film to be referred to in order to convert the video signal; and
a film color conversion unit which converts the video signal by referring to a characteristic of the selected type of the film.

11. The apparatus of claim 10, wherein the characteristic of the film is determined according to at least one of the film spectral sensitivity, reflection ratio and transmission ratio of the film.

12. The apparatus of claim 10, wherein the film color conversion unit comprises:
an energy conversion unit which converts each RGB value of an input image to an energy value of the film indicating a degree that the film is exposed to light;
a pigment concentration conversion unit which converts the energy value to a pigment concentration value of the film indicating a degree that the pigment is deposited on the film; and
a tristimulus conversion unit which converts the pigment concentration value to a tristimulus value.

13. The apparatus of claim 12, wherein the pigment concentration conversion unit comprises:
an energy-density conversion unit which converts the energy value of the film to a density value of the film indicating an exposure degree of the film; and
a density-pigment concentration conversion unit which converts the density value of the film to the pigment concentration value of the film.

14. The apparatus of claim 12, wherein the tristimulus conversion unit comprises:
a pigment concentration-spectral density conversion unit which converts the pigment concentration value of the film to a spectral density value of the film indicating a density value of the film with respect to each of a plurality of wavelengths;
a spectral density-spectral transmission conversion unit converting the spectral density value of the film to a spectral transmission value of the film indicating a transmission ratio of the film with respect to each of the plurality of wavelengths; and
a spectral transmission-tristimulus conversion unit converting the spectral transmission value of the film to the tristimulus value.

15. The apparatus of claim 10, further comprising a tristimulus adjustment unit adjusting a tristimulus value based on information on an external environment in which the video signal is reproduced.

16. The apparatus of claim 15, wherein the information on the external environment includes information on illumination and chromaticity.

17. The apparatus of claim 10, further comprising an RGB conversion unit converting a tristimulus value to an RGB value adjusted based on the characteristic of color reproduction of an apparatus to reproduce the video signal.

18. The apparatus of claim 10, further comprising:
an inverse gamma correction unit performing inverse gamma correction of the video signal in which a nonlinear signal is converted to a linear signal; and
a gamma correction unit performing gamma correction of the video signal in which the linear signal is converted to a nonlinear signal, in relation to the video signal which is converted to have a color impression of the selected film.

19. A computer readable recording medium having embodied thereon a computer program for executing a method of converting a video signal, the method comprising:
selecting a type of film to be referred to in order to convert the video signal; and
by referring to the characteristic of the selected type of the film, converting the video signal.
